(19) United States
(12) Patent Application Publication
(10) Pub. No.: US 2024/0303184 A1
(43) Pub. Date: Sep. 12, 2024

(54) INTELLIGENT TEST CASE MANAGEMENT IN COMPUTER SOFTWARE APPLICATIONS

(71) Applicant: INTERNATIONAL BUSINESS MACHINES CORPORATION, ARMONK, NY (US)

(72) Inventors: Su Liu, Austin, TX (US); Hamid Majdabadi, OTTAWA (CA); Nageswara Sastry Renduchintala, Bengaluru (IN); Janani Janakiraman, Austin, TX (US)

(21) Appl. No.: 18/180,193

(22) Filed: Mar. 8, 2023

(51) Int. Cl. G06F 11/36

(52) U.S. Cl. CPC G06F 11/3684

(57) ABSTRACT

A computing device for automatic management of test cases for testing of source code associated with computer software applications. The computing device accesses an original corpus of source code. One or more previously-generated test cases associated with the original corpus of source code are accessed. An updated corpus of source code is accessed, the updated corpus of source code an update from the original corpus of source code. The computing device generates automatically one or more new test cases for testing of the updated corpus of source code, the one or more new test cases automatically generated based upon the accessed one or more previously-generated test cases. The updated corpus of source code is compiled. The compiled updated corpus of source code is executed with the one or more new test cases.

### FIELD OF THE INVENTION

The present invention relates generally to software development and more particularly to intelligent test case generation and management in computer software applications.

### BACKGROUND

The present embodiments relate to test case management in computer software applications. As the software industry continues to grow in total value and the relative value of software to the public at large increases as well, the volume and complexity of software development projects is also dramatically increasing. Correspondingly, an increased need presents itself to test and confirm that these software development projects are functioning correctly for utilization by the public-at-large, or in other ways. This requires an increasing amount of effort and manhours spent. As any developer knows, new software rollouts also require a large amount of testing to ensure that the software is functioning as it should, without errors, bugs, crashes, memory management issues, or other problems. Resolving these issues requires a significant amount of manpower to be expended, particularly in the case of complex software applications. Typically, test cases are used by developers to allow testing of computer software applications, including the output of the entirety of an application, or merely the testing of newly deployed objects, classes, interfaces, libraries, etc. In sum, all testing, though time-consuming, must be performed in order to confirm the software is functioning as it should be. Since these new software development projects have become so complex and numerous, a need presents itself for an improved manner of testing software in a streamlined and expedited manner.

### SUMMARY

Embodiments of the present invention disclose a method, system, and computer program product for automatic management of test cases for testing of source code associated with computer software applications. A computing device accesses an original corpus of source code. The computing device accesses one or more previously-generated test cases associated with the original corpus of source code. The computing device accesses an updated corpus of source code, the updated corpus of source code an update from the original corpus of source code. The computing device automatically generates one or more new tests cases for testing of the updated corpus of source code, the one or more new test cases automatically generated based upon the accessed one or more previously-generated test cases. The computing device compiles the updated corpus of source code. the computing device executed the compiled updated corpus of source code for utilization with one or more new test cases.

### BRIEF DESCRIPTION OF THE DRAWINGS

FIG. 1 represents a networked computer environment 100, in accordance with an embodiment of the present invention.

FIG. 2 is a functional block diagram illustrating modules 200 for automatic test case management associated with testing of source code associated with computer software applications, in accordance with an embodiment of the present invention.

FIGS. 3A and 3B are a flowchart depicting operational steps that a hardware component of a hardware appliance may execute, in accordance with an embodiment of the invention.

### DETAILED DESCRIPTION

Test case management, as widely known by developers at large, is an important part of software development. Rigorous testing of inputs, outputs, environmental settings, system settings, memory addresses, etc. associated with computer software can be a demanding, time-consuming, and tedious task for developers, even if only a small portion of the computer software is being tested at any one time. Software development of valuable and complicated software applications can be a very substantial undertaking, considering situations such as when there may be millions of lines of source code in a computer software application, any of which can be prone to a typographical error. This process, as one of skill in the art understands, may be very prone to mistakes being made since one typographical error (for example, misspelling of terms within a call for an object), can cause the entire corpus of source code to not compile, throw exceptions, etc., or even worse compile, but not work for its intended purpose and provide bad results, etc. Considering the current role of computer software in, for example, airline flight management, the power grid, and banking, this can lead to real-world glitches which could, for example, lead to the delay of airline flights all over the world, power outages, or unavailability of credit card processing for an entire region, because of simple typographical errors.

Embodiments of the invention are directed towards one or more methods, systems, and computer program products for automatic management of test cases associated with testing of source code associated with computer software applications. The presently disclosed embodiments may function as a part of an integrated development environment, as a plug-in to an integrated development environment, function independently (via a separately executing computer application, etc.), or in some other manner while being contemplated by embodiments of the invention disclosed herein.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as associated with a modules 200 for automatic test case management associated with computer software applications. In addition to modules 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and modules 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

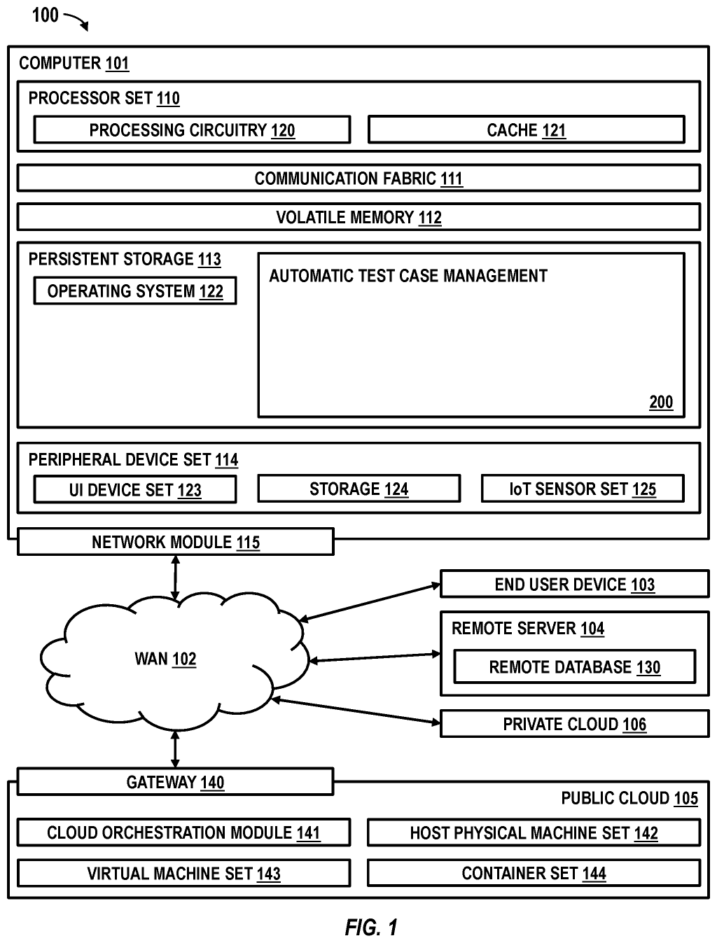

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processor set 110 may be alternatively be referred to herein as one or more “computing device(s),” but computing devices may also refer to one or more CPUs, microchips, integrated circuits, embedded systems, or the equivalent, presently existing or after-arising. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in modules 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in modules 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

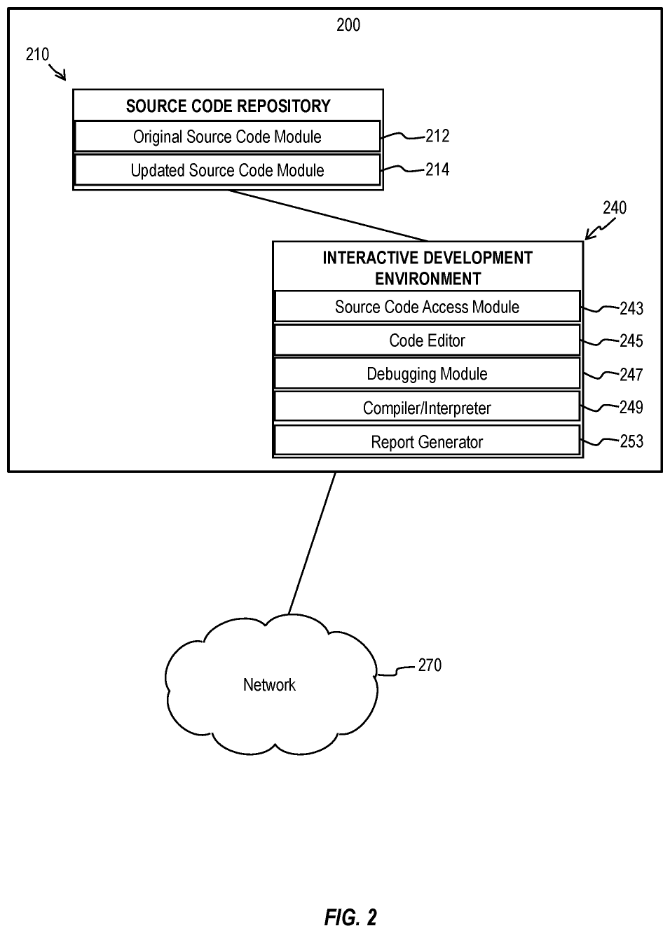

FIG. 2 is a functional block diagram illustrating modules 200 for automatic test case management for testing of source code associated with computer software applications, in accordance with an embodiment of the present invention. In an exemplary embodiment as displayed in FIG. 2, source code repository 210 is operatively connected to interactive development environment 240, directly or via network 270. Source code repository 210 may be any sort of computer software (and, in various embodiments, associated computer hardware) for storing, accessing, and/or communicating one or more versions, bodies, or other corpuses of source code for utilization as discussed herein. While still contemplated as within the scope of the invention, interactive development environment 240 as shown in FIG. 2 may be replaced or supplemented with any sort of computing environment capable of automatically managing test cases associated with a corpus of source code. Source code stored in source code repository 210 may be in the form Java®, C++, Basic, JavaScript®, or any other presently existing or after-arising programming language that would benefit from embodiments of the presently disclosed invention. As discussed further herein, different versions of source code from source code repository 210 may be checked-out, read, or otherwise accessed by interactive development environment 240 for further utilization in connection with embodiments discussed herein. Different versions of source code available from source code repository 210 may be an original corpus of source code, as well as one or more updates, modifications, new versions, etc. to the original corpus of source code. As different versions of source code from source code repository 210 are modified by developers or in other ways, the present invention presents a streamlined way of automatically generating and managing test cases for the new versions of source code stored by the source code repository 210. Even a small, seemingly inconsequential change made to source code and reflected in an “updated corpus of source code” (for example, changes to source code for one object in millions of lines of source code), may require generation of a large number of new test cases for complete and thorough testing of an important product.

In various embodiments of the invention, interactive development environment 240 in conjunction with accessing an original corpus of source code available from source code repository 210, also accesses one or more previously-generated test cases that are associated with the original corpus of source code available from source code repository 210, as well as, in other embodiments of the invention, verification events, and/or associated environmental data. As would be understood by one of skill in the art, “test cases” refers to one or more of inputs, execution conditions, testing procedures, and expected results that are related to one or more tests to be performed in connection with testing of a software application (or, in effect, compiled/interpreted/scripted source code as maintained by source code repository 210). Test cases may be directed towards one portion of a corpus of source code (such as an object or an interface, etc.), or an entire corpus of source code. Also as discussed further herein, the one or more previously-generated test cases may be generated manually by a developer (or developers), auto-generated, pre-configured, created by previous iterations of embodiments of the invention, or created in any other way. Test cases, verification events, environmental data, etc. may be stored directly by source code repository 210 in connection with corpuses of source code, stored by interactive development environment 240, or stored in another way. Interactive development environment 240 then accesses an updated, modified, versioned, etc. updated corpus of source code also available from the source code repository 210. Interactive development environment 240 then, as further discussed herein, then automatically generates one or more new test cases for testing of the updated corpus of source code. The one or more new test cases, in various embodiments of the invention, are automatically generated based upon the accessed one or more previously-generated test cases, as further discussed herein.

Interactive development environment 240 then, in various embodiments of the invention, proceeds to test the updated corpus of source code with the automatically generated one or more new test cases. In embodiments where the updated corpus of source code must be compiled before execution, interactive development environment 240 may compile and execute the updated corpus of source code, then run a debugger sequence in the compiled corpus of source code using the one or more new test cases. In embodiments where the updated corpus of source code is written in a scripted or interpreted programming language, interactive development environment 240 may execute the scripted/interpreted language with the one or more new test cases. The results of execution/interpretation/etc. of the updated corpus of source code executed with the one or more new test cases are recorded, and, in various embodiments, a report is automatically created, the report including results of execution of the compiled/scripted/interpreted/etc. updated corpus of source code utilizing the one or more new test cases. Contents of the report generated by interactive development environment 240 are further discussed herein.

As further displayed in FIG. 2, in various embodiments of the invention, source code repository 210 and interactive development environment 240 are connected to and via network 270. In various embodiments, network 270 represents, for example, any sort of computer network such as a local area network (LAN), a wide area network (WAN) such as the Internet, and includes wired, wireless, or fiber optic connections. In various embodiments, network 270 is substantially the same as WAN 102, discussed in connection with FIG. 1 herein. In general, network 270 may be any combination of connections and protocols that will support communications between source code repository 210 and interactive development environment 240, in accordance with embodiments of the invention. In further embodiments of the invention, network 270 may represent an internal bus associated with a single or multicore processor executing both computer messaging software 210 and computer messaging software analyzer 240 (such as in an embodiments where source code repository 210 and interactive development environment 240 are integrated).

Discussing elements displayed in FIG. 2 in further detail, source code repository 210 represents computer software (and, in various embodiments, associated computer hardware) for storing, accessing, and/or communicating one or more versions, bodies, or other corpuses of source code for utilization as discussed herein. In various embodiments of the invention, source code repository 210 includes one or more of original source code module 212 and/or updated source code module 214. In various embodiments of the invention, source code repository 210 is integrated as part of interactive development environment 240, stand-alone software, or separated by network 270.

Original source code module 212 represents software and/or hardware for storage, maintenance, checking-in, checking-out, etc. of an original corpus of source code (“original” as versus the “updated” source code stored in updated source code module 214, as further discussed herein). As discussed elsewhere herein, source code stored by original source code module 212 may be in the form of Java®, C++, Basic, JavaScript®, or any other presently existing or after-arising programming language that would benefit from embodiments of the presently disclosed invention. Source code stored by original source code module 212 and updated source code module 214 may be any type of source code, presently existing or after-arising, and may contain, for example, source code for an application, library, object, interface, etc., a sandbox source code change, log file(s), a demo(s), and/or one or more environmental settings, any of which may be included in the source code or stored independently. Original source code module 212 makes available source code for interactive development environment 240. Source code stored by original source code module 212 may be dynamically edited, compiled, interpreted, scripted, executed with test cases, etc. as discussed further herein. Test cases associated with testing of original corpus of source code may be stored by original source code module 212, stored in connection with interactive development environment 240 (as further discussed) or elsewhere. Test cases stored in original source code module 212 may also include, for example, a range of possible inputs for inputting into compiled/interpreted/scripted source code, inputs for objects/classes/interfaces/etc.

associated with the corpus of source code, hypothetical mouse movements (or other graphical user interface interactions, one or more key test scripts used in testing of the corpus of source code (as well as one or more mappings mapping the one or more key test scripts to one or more features of the original corpus of source code), or anything of the like, as one of skill in the art would understand. Test cases are utilized for automatic generation of new tests cases, as further discussed herein.

Updated source code module 214 represents software and/or hardware for storage, maintenance, checking-in, checking-out, etc. of an updated, modified, versioned, etc. corpus of source code reflecting updates, changes, and/or edits to the “original” corpus of source code stored in original source code module 212. As would be understood by one of skill in the art, application and software development frequently requires a large number of edits, changes, additions, subtractions, etc. to corpuses of source code before a project is completed, leading to a number of different versions of source code which would be stored by updated source code module 214, and an “original” corpus of source code stored by original source code module 212 may be an “updated” corpus of source code from a previous iteration of the invention. Even after roll-out, new versions may be implemented. As with original source code module 212, updated source code module 214 may be dynamically edited compiled, interpreted, scripted, executed, etc. with new test cases. Updated corpuses of source code accessed by interactive development environment 240 are tested with automatically generated new test cases, in various embodiments of the invention, as further discussed. In various embodiments of the invention, updated source code module 214 may be integrated with original source code module 212, stored in connection with interactive development environment 240, stored in connection with independently functioning software, etc.

Continuing with regard to FIG. 2, interactive development environment 240 includes, in various embodiments of the invention, source code access module 243, code editor 245, debugging module 247, compiler/interpreter 249, and report generator 253. As discussed elsewhere herein, interactive development environment 240 may be replaced or supplemented with any sort of computing environment capable of automatically managing test cases associated with a corpus of source code, with functionality as discussed herein.

Source code access module 243 represents software and/or hardware for accessing of corpuses of source code from source code repository 210. The corpuses of source code can be checked-out, read, or otherwise accessed from original source code module 212 and/or updated source code module 214. In various embodiments of the invention, after source code access module 243 accesses an original corpus of source code from original source code module 212, source code access module 242 accesses an updated corpus of source code from updated source code module 214. Corpuses of source code checked-out of source code access module 243 can, in various embodiments of the invention, be edited by one or more developers using code editor 245, debugged by debugging module 247, compiled/interpreted/scripted by compiler/interpreter 249, and having relevant reports generated for user(s) by report generator 253 (the reports including, in various embodiments, results of execution, errors associated with execution, etc., as further discussed herein). After access of any relevant corpuses of source code by source code access module 243 from source code repository 210, such source code becomes available to a developer in interactive development environment 240, for viewing, editing, modifying, compiling and/or debugging source code.

Code editor 245 represents software and/or hardware for editing of various source code accessed, checked-out, read, etc. from source code repository 210. As one of skill in the art understands, since source code is typically written in text, code editor 245 provides various facilities for developers to view and edit syntax of source code, and frequently provides functionality to highlight, comment, autocomplete, indent, request debugging (such as by debugging module 247), request compilation or execution (such as by compiler/interpreter 249), etc., in order to facilitate one or more developers to efficiently develop software. In various embodiments of the invention, code editor 245 may be a standalone application or built into integrated development environment 240. Code editor 245, in various embodiments of the invention, may access original source code module 212 in order for one or more developers to edit the original corpus of source code in order to generate a modified corpus of source code, the modified corpus of source code to be tested by debugging module 247, as further discussed herein. As one of skill in the art understands, in industry-standard professional development environments, corpuses of source code are typically checked-out when a developer works on the source code with code editor 245 then checked-in when the work is done (in order to maintain copies of source code, determine ownership of code, who made certain changes to the source code, etc.).

Debugging module 247 represents software and/or hardware for automatically debugging corpuses of source code accessed, checked-out, etc. by interactive development environment 240. Debugging module 247 may be implemented as a plug-in to interactive development environment 240, as a stand-alone application, or in another manner. In various embodiments of the invention, debugging module 247 serves to automatically generate one or more new test cases for testing of the updated corpus of source code retrieved from updated source code module 214. As discussed herein, in order to automatically generate one or more new tests cases, invention debugging module 247 accesses stored previously-generated test cases associated with an original corpus of source code (or other versions, roll-outs, etc. of source code). As each version, etc. of source code is rolled out by developers, and stored by source code repository 210, one or more previously-generated test cases associated with each version of source code is stored by debugging module 247 (or becomes available to debugging module 247 in some way).

Previously-generated test cases accessed by debugging module 247 are associated with any corpus of source code previously available, and may be generated manually by a developer (or developers), auto-generated (such was with previous iterations of embodiments of the invention), pre-configured, or created in any other way. As mentioned herein, previously generated test cases may include by non-limiting example, a range of possible inputs for inputting into compiled/interpreted/scripted source code, inputs for objects/classes/interfaces/etc. associated with source code, hypothetical mouse movements (or other graphical user interface interactions), one or more key test scripts used in testing of the corpus of source code (including mappings mapping the one or more key test scripts to one or more features of the original corpus of source code), or the equivalent presently existing or after-arising, any of which may be used for testing corpuses of source code. Debugging module 247 may store and access such previously-generated test cases directly, store test cases in source code repository 210, or test cases may be stored elsewhere in modules 200. After access by debugging module 247 of previously-generated test cases, debugging module 247 automatically generates one or more new test cases for testing of the updated corpus of source code available from updated source code module 214, based upon the accessed previously generated test cases.

In various embodiments of the invention, one or more machine learning models associated with debugging module 247 are involved in the generation of one or more new tests cases for testing of the updated corpus of source code. The machine learning models may rely, for example on a neural network to provide necessary functionality, or any other machine learning technique as is commonly understood by one of skill in the art. Other machine learning techniques specifically contemplated include long-short term memory, a multilayer perceptron, or a type of feed-forward neural network. Debugging module 247 acts in conjunction with compiler/interpreter 249 to thoroughly test corpuses of source code, as further discussed below.

In embodiments of the invention where machine learning models are utilized, machine learning models may be trained in a supervised, unsupervised, or semi-supervised manner with previously-generated test cases known to provide thorough and full testing of corpuses of source code as well as the results of execution of previously compiled/interpreted/scripted corpuses of source code. In situations where the previously generated test cases are associated with a range of possible inputs for inputting into compiled/interpreted/scripted source code, machine learning models may be trained to recognize both the various of possible inputs associated with previous corpuses of source code, as well as changes made to previous corpuses of source code, where test cases are input into, and the expected results. So, the machine learning models trained in such a way will be capable of testing an updated corpus of source code in a similar manner, but in an automated fashion and can provide results without a necessity of a human manually creating test cases. Similarly, in situations where graphical user interface interactions or key test scripts are used in testing previous corpuses of source code, historical graphical user interface interactions or historical key test scripts, as well as the previous corpuses of source code themselves, the results of testing, etc. are used in training machine learning models for testing of new corpuses of source code. Previous and current environmental settings may be accessed as well, in any embodiment of the invention, in generated new test cases, and the past or current environmental settings utilized in generating new test cases. After-arising means of testing of source code with test cases are specifically contemplated as being within the scope of the invention.

Compiler/interpreter 249 represents software and/or hardware for compiling, interpreting, scripting, etc. corpuses of source code provide by source code repository 210. The specific action performed by compiler/interpreter 249 depends on the type of programming language being considered, as would be understood by one of skill in the art, and depends on whether a language is a scripting language, interpreted language, compiled language, etc. In various embodiments of the invention, after one or more new test cases are generated automatically by debugging module 247 (with actions as discussed elsewhere herein), compiler/interpreter 249 executes a compiled/scripted/interpreted/etc. version of the updated corpus of source code (from updated source code module 214) with generated one or more new test cases to thoroughly test the updated corpus of source code.

Compiler/interpreter 249 therefore acts in conjunction with debugging module 247 to execute compiled/interpreted/scripted/etc. versions of the updated corpus of source code with the one or more new test cases. Generally, compiler/interpreter 249 and debugger 247 work in conjunction to assess whether the updated corpus of source code executes correctly, for its intended purpose, and provides the correct results with the generated one or more new test cases. In situations where the updated corpus of source code is compiled, for example, compiler/interpreter 249 and debugger 247 confirm that the corpus of source code is compiling correctly or refuses to compile, and records errors generated. In situations where the updated corpus of source is compiled and compiled correctly, compiler/interpreter 249 and debugger 247 confirms that an automated execution of the updated corpus of source code with the generated one or more new test cases is providing correct results (such, for example, where the updated corpus of source code is an object or an interface, confirming that the output of the object/interface is correct). In various embodiments of the invention, results of execution are utilized by report generator 253 to generate a report for one or more users to assess results of execution.

In various embodiments of the invention, exactly how compiler/interpreter 249 performs the testing depends on the nature of the generated one or more new test cases. In situations where the generated one or more new test cases are a range of inputs to be entered into the updated corpus of source code, compiler/interpreter 249 simply executes the source code in an appropriate manner with the inputs in place, and determines whether the program didn't compile, execute, crashed, and the errors or results generated. In embodiments where the one or more new test cases simulate graphical user interface interactions or key test scripts, the results of interactions or key test scripts are similarly recorded for errors, crashing, incorrect results, etc.

Report generator 253 represents software and/or hardware for automated generation of reports associated with results of execution of updated corpuses of source code, in embodiments of the invention. Report generator 253, in the various embodiments of the invention, may be a standard part of interactive development environment 240, an optional plug-in for interactive development environment 240, or a stand-alone application in communication with interactive development environment 240 over network 270. Report generator 253 provides specialized reports for developers associated with the updated corpus of source code, users, project managers, etc., to assist them in further debugging of the updated corpus of source code, with the content of the report differing in various embodiments of the invention. In embodiments of the invention report generator 253 may include a text (such as a logfile) or graphical user interface display providing details such as errors during compilation, results of execution of the updated corpus of source code with the one or more new test cases, associated environmental settings, memory utilization, cpu processor time, etc. The specialized reports created by report generator 253 may be utilized by developers, users, project managers, etc. in improving new versions of source code, or simply correcting errors in the current version. Specialized reports may simply take the form of a .txt file, another file format, an automated e-mail, a pop-up appearing on the screen of code-editor 245, or the equivalent. In further embodiments of the invention, specialized reports generated by report generator 253 may include a “how-to” document indicating to viewers how to correct potential compilation or run-time errors, which could automatically scroll the point to the corpus of source code, and even suggest code edits which will correct errors (such as via utilization of accessing a director of similar errors, a natural language model or generative neural network). In embodiments where no errors are present during compilation or run-time, the specialized report may contain no potential errors and simply indicate “no errors found.”

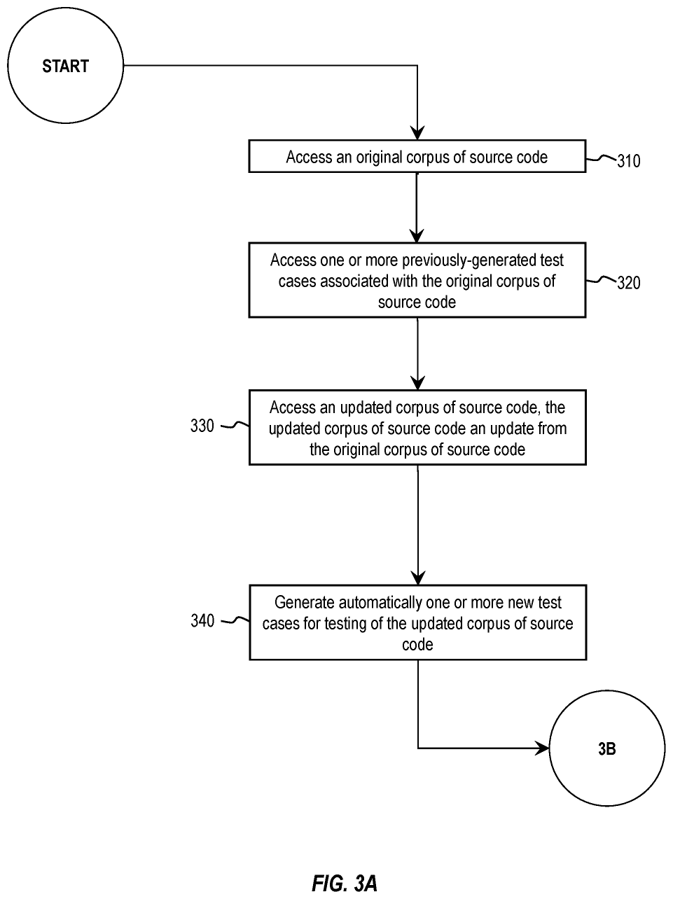

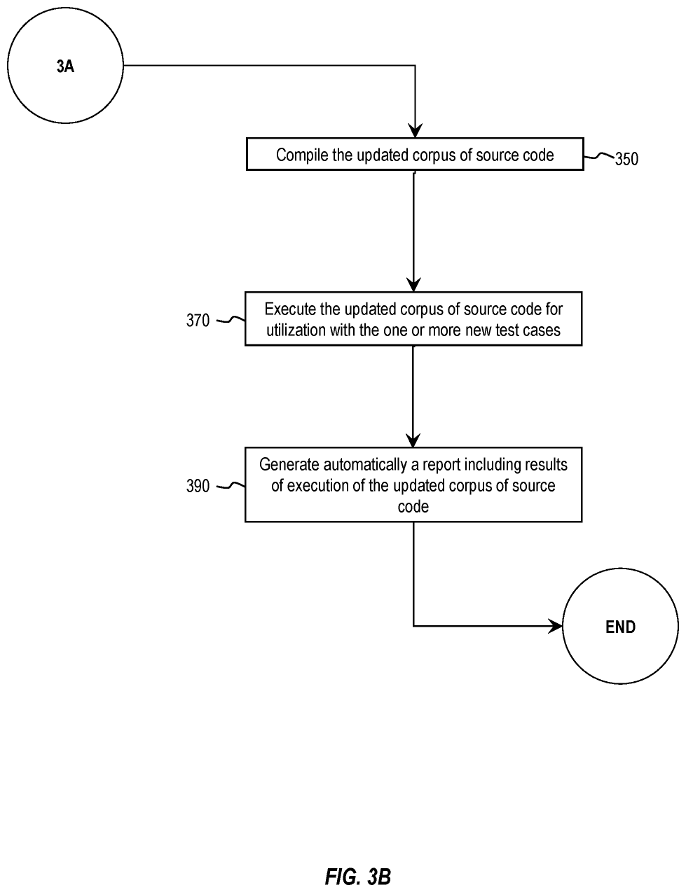

FIGS. 3A and 3B are a flowchart depicting operational steps that a hardware component, multiple hardware components, and/or a hardware appliance may execute, in accordance with an embodiment of the invention. As shown in FIG. 3A, at step 310 a computing device accesses an original corpus of source code available from original source code module 212 of source code repository 210. At step 320, the computing device accesses one or more previously-generated test cases associated with the original corpus of course code, that, in an embodiment of the invention, are stored by source code repository 210 (in other embodiments of the invention, the one or more previously-generated test cases are stored elsewhere, such as directly by interactive development environment 240). At step 330, the computing device accesses an updated corpus of source code, the updated corpus of source code available from updated source code module 214. The update, new version, etc. has other modifications from the original corpus of source code, as discussed elsewhere herein. At step 340, the computing device generates one or more new test cases for testing of the update corpus of source code. In various embodiments of the invention, this step is performed by debugging module 247. Generation of the one or more new test cases is discussed more extensively elsewhere herein, such as in connection with FIG. 2.

Continuing in FIG. 3B, at step 350 the computing device (specifically, in various embodiments of the invention, compiler/interpreter 249) compiles the updated corpus of source code. As discussed elsewhere herein, in other embodiments of the invention, the updated corpus of source code may be interpreted or scripted, and execution proceeds in accordance with At step 370, the computing device (specifically, compiler/interpreter 249 in conjunction with debugging module 247) executes the updated corpus of source code for utilization with the one or more new test cases. At step 390, in various embodiments of the invention, computing device automatically generates a report including results of execution of the updated corpus of source code, such as if any errors have been reported. The report may contain a how-to document on how to fix potential errors in the source code.

Based on the foregoing, a method, system, and computer program product have been disclosed. However, numerous modifications and substitutions can be made without deviating from the scope of the present invention. Therefore, the present invention has been disclosed by way of example and not limitation.

What is claimed is:

1. A method using computing device for automatic management of test cases for testing of source code associated with computer software applications, the method comprising:
accessing by a computing device an original corpus of source code;
accessing by the computing device one or more previously-generated test cases associated with the original corpus of source code;
accessing by the computing device an updated corpus of source code, the updated corpus of source code an update from the original corpus of source code;
generating by the computing device automatically one or more new test cases for testing of the updated corpus of source code, the one or more new test cases automatically generated based upon the accessed one or more previously-generated test cases;
compiling by the computing device the updated corpus of source code; and
executing the compiled updated corpus of source code for utilization with one or more new test cases.

2. The method of claim 1, wherein the original corpus of source code and the updated corpus of source code are available in an interactive development environment.

3. The method of claim 2, wherein the automatically generated one or more new test cases are generated by a software tool plug-in associated with the interactive development environment.

4. The method claim 1, wherein the updated corpus of source code is a new version of the original corpus of source code.

5. The method of claim 1, where the original corpus of source code includes selectively one or more of the following: a sandbox source code change, a log file, a demo, and one or more environmental settings.

6. The method of claim 1, further comprising:
accessing one or more original environmental settings associated with the original corpus of source code;
accessing one or more updated environmental settings associated with the updated corpus of source code; and
using the one or more original environmental settings and the one or more updated settings in generating the one or more new test cases.

7. The method of claim 1, wherein the one or more new test cases are stored in a specialized data structure.

8. The method of claim 1, further comprising generating automatically a report including results of execution of the compiled updated corpus of source code utilizing the one or more new test cases.

9. The method of claim 8, wherein the report including results of execution of the compiled updated corpus of source code also includes a how-to document.

10. The method of claim 8, wherein the report includes zero or more errors associated with execution of the compiled updated corpus of source code.

11. The method of claim 1, wherein the one or more new test cases are generated by a software tool using artificial intelligence.

12. The method of claim 11, wherein the software tool using artificial intelligence is trained using a plurality of sets of previous test cases and results of execution of the plurality of previous sets of test cases on previously compiled corpuses of source code.

13. The method of claim 11, wherein the software tool using artificial intelligence uses a neural network, long-short term memory, a multi-layer perceptron, or a feed-forward neural network.

14. A computer system for automatic management of test cases for testing of source code associated with computer software applications, the computer system comprising:
one or more computer processors;
one or more computer-readable storage media;
program instructions stored on the computer-readable storage media for execution by at least one of the one or more processors, the program instructions comprising:
program instructions to access by a computing device an original corpus of source code;
program instructions to access by the computing device one or more previously-generated test cases associated with the original corpus of source code;
program instructions to access by the computing device an updated corpus of source code, the updated corpus of source code an update from the original corpus of source code;
program instructions to generate by the computing device automatically one or more new test cases for testing of the updated corpus of source code, the one or more new test cases automatically generated based upon the accessed one or more previously-generated test cases;
program instructions to compile by the computing device the updated corpus of source code; and
program instructions to execute the compiled updated corpus of source code for utilization with one or more new test cases.

15. The computer system of claim 14, further comprising program instructions to automatically generate a report including results of execution of the compiled updated corpus of source utilizing the one or more new test cases.

16. The computer system of claim 15, wherein the report including results of execution of the compiled updated corpus of source code also contains a how-to document.

17. The computer system of claim 15, wherein the report includes zero or more errors associated with execution of the compiled updated corpus of source code.

18. A computer program product using a computing device for automatic management of test cases for testing of source code associated with computer software applications, the computer program product comprising:
one or more non-transitory computer-readable storage media and program instructions stored on the one or more non-transitory computer-readable storage media, the program instructions, when executed by the computing device, cause the computing device to perform a method comprising:
accessing by a computing device an original corpus of source code;
accessing by the computing device one or more previously-generated test cases associated with the original corpus of source code;
accessing by the computing device an updated corpus of source code, the updated corpus of source code an update from the original corpus of source code;
generating by the computing device automatically one or more new test cases for testing of the updated corpus of source code, the one or more new test cases automatically generated based upon the accessed one or more previously-generated test cases;
compiling by the computing device the updated corpus of source code; and
executing the compiled updated corpus of source code for utilization with one or more new test cases.

19. The computer program product of claim 17, wherein the one or more new test cases are generated by a software tool using artificial intelligence.

20. The method of claim 19, wherein the software tool using artificial intelligence is trained using a plurality of sets of previous test cases and results of execution of the plurality of previous sets of test cases on previously compiled corpuses of source code.
